(19) United States
(12) Patent Application Publication
(10) Pub. No.: US 2025/0285191 A1
(43) Pub. Date: Sep. 11, 2025

(54) Machine Learning Systems and Methods for Automatic Photo Labeling and Filing

(71) Applicant: Xactware Solutions, Inc., Lehi, UT (US)

(72) Inventors: Jacob Jenson, Eagle Mountain, UT (US); Larisa Williams, Provo, UT (US)

(73) Assignee: Xactware Solutions, Inc., Lehi, UT (US)

(21) Appl. No.: 19/073,878

(22) Filed: Mar. 7, 2025

Related U.S. Application Data
(60) Provisional application No. 63/562,862, filed on Mar. 8, 2024.

(51) Int. Cl. G06Q 40/08; G06N 20/00; G06V 10/44; G06V 10/94; G06V 20/50; G06V 20/70

(52) U.S. Cl. CPC G06Q 40/08; G06N 20/00; G06V 10/44; G06V 10/945; G06V 20/50; G06V 20/70

(57) ABSTRACT

Machine learning systems and methods for automatic photo labeling and filing are provided. The system operates in conjunction with a claims estimation software application to rapidly and automatically label one or more photos associated with an insurance claim, and to automatically file such photos in one or more albums of a claim file, using machine learning techniques. The system retrieves a photo, processes the photo to detect one or more features depicted in the photo, generates a label for the photo based on the detected one or more features, assigns the label to the photo, determines a correct photo album of an insurance claim file, and stores the labeled photo in the correct photo album of the claim file.

### RELATED APPLICATIONS

This application claims priority to U.S. Provisional Patent Application No. 63/562,862 filed on Mar. 8, 2024, the entire disclosure of which is hereby expressly incorporated by reference.

### BACKGROUND

### Technical Field

The present disclosure relates generally to the field of machine learning. More specifically, the present disclosure relates to machine learning systems and methods for automatic photo labeling and filing.

### Related Art

In the field of computer-based insurance claims estimation systems, the need to rapidly and accurately identify photos of assets and to include the same in computer-based claim estimation files is paramount. Current users of such claims estimation systems manually take pictures of assets (e.g., pictures of various objects within structures/rooms, and/or pictures of various attributes of such structures/rooms) and manually load them into one or more albums within an electronic claim file or capture the images within an application executing on a device (e.g., on a smart phone) and organize such images into folders or groups, rooms, or areas. Once the pictures have been taken and filed in the correct album, the user can perform a bulk edit to manually label each picture in the album, and/or perform specific manual labelling of particular photos in an album. This process is time-consuming and prone to errors. For example, it is estimated that it can take an insurance adjuster, contractor, or technician up to 30-45 minutes per claim to manually label and file photos. Also, since file reviewers need to review all of the labeling of photos in order to see and verify damages of an insurance claim, it is very hard for such reviewers to put images into context, especially without appropriate labeling. Further, if images are not filed in the correct albums and in the correct order, it can be difficult, if not impossible, for a reviewer to properly process an insurance claim or scope of damages. Still further, existing insurance claims estimation systems lack adequate facilities for searching through images within a claim file as well as across an organization.

Accordingly, what would be desirable are machine learning systems and methods for automatic photo labeling and filing which address the foregoing and other needs.

### SUMMARY

The present disclosure relates to machine learning systems and methods for automatic photo labeling and filing. The system operates in conjunction with a claims estimation software application (e.g., as a background process called by the claims estimation software application) to rapidly and automatically label one or more photos associated with an insurance claim, and to automatically file such photos in one or more albums of a claim file, using machine learning (e.g., object detection) techniques. The system retrieves a photo (e.g., a photo taken by a smart phone or from some other source), processes the photo to detect one or more features depicted in the photo, generates a label for the photo based on the detected one or more features, assigns the label to the photo, determines a correct photo album of an insurance claim file, and stores the labeled photo in the correct photo album of the claim file.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating the machine learning system of the present disclosure;

FIG. 2 is a flowchart illustrating processing steps carried out by the system of FIG. 1;

FIG. 3 is a flowchart illustrating further processing steps carried out by the system of FIG. 1; and

FIGS. 4-32 are screenshots illustrating various user interface screens generated by the system of the present disclosure.

### DETAILED DESCRIPTION

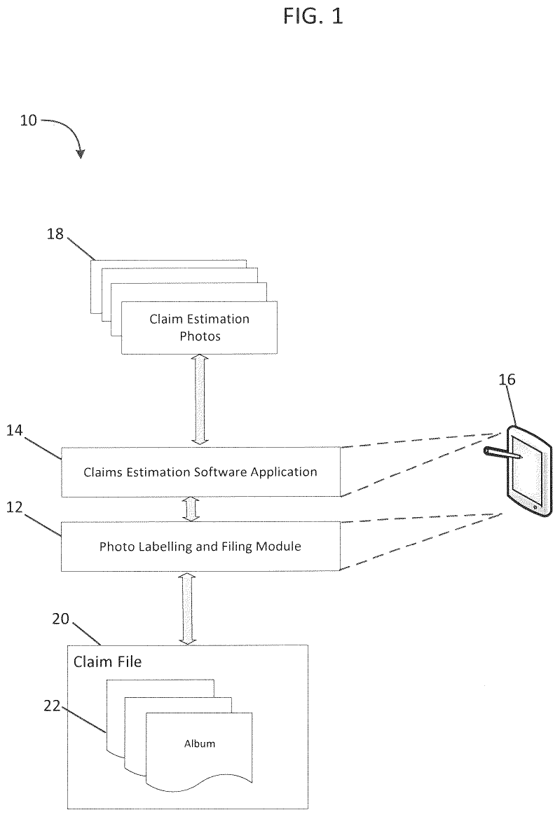

The present disclosure relates to machine learning systems and methods for automatic photo labeling and filing, as described in detail below in connection with FIGS. 1-32.

FIG. 1 is a diagram illustrating the system of the present disclosure, indicated generally at 10. The system 10 includes a photo labeling and filing software module 12 stored on and/or executed by a computing device 16, such as a smart phone, a tablet computer, a laptop computer, a server, or other type of computer system. Further, the computing system 16 could also include a cloud-based computing platform. The module 12 interacts with a claims estimation software application 14, which could also be stored on and/or executed by the computing system 16, or on another computer system in communication with the computing system 16. As described in detail herein, the photo labeling and filing module 12 automatically labels one or more claim estimation photos 18 associated with an insurance claim being processed by the claims estimation software application 14. Additionally, the module 12 automatically files one or more of the claim estimation photos 18 in one or more appropriate albums 22 of an insurance claim file 20. Such claim file 20 could be maintained by the claims estimation software application 14. Advantageously, the module 12 allows for rapid and automatic labeling of images. Additionally, as discussed below, the module 12 could execute one or more object detection algorithms/software modules in order to automatically identify objects in the one or more photos 18, and can utilize the detected objects to automatically label and file photos based upon the detected objects.

The claim estimation photos 18 could be captured using a camera of the computing device 16 (e.g., a camera of a smart phone), or otherwise obtained. Further, the module 12 could execute in combination with the claims estimation software application 14, e.g., as a background process that is called by the claims estimation software application 14 when it is necessary to label one or more of the photos 18 and to file such photos in one or more of the albums 22 of the claim file 20. The claim file 20 could be an electronic file maintained by the claims estimation software application 14 or some other application, and could include the associated one or more albums 22. It is noted that the claims estimation software application 14 could be any suitable, commercially-available claims estimation software applications, such as, but not limited to, those sold by Xactware Solutions, Inc., or other suitable claims estimation software applications. Additionally, the photo labeling and filing module 12 could be programmed in any suitable high- or low-level programming languages, including, but not limited to, C, C++, C#, Java, JavaScript, Python, Perl, Ruby, or any other suitable programming language. The photo labeling and filing module 12 could be embodied as computer readable instructions stored on a non-transitory memory of the computing device 16, including, but not limited to, flash memory, disc memory, or other suitable memory.

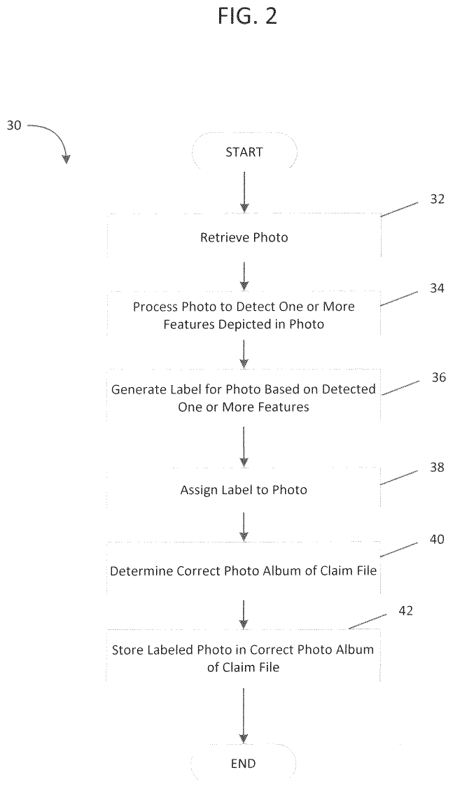

FIG. 2 is a flowchart, indicated generally at 30, illustrating process steps carried out by the system 10 of FIG. 1. Beginning in step 32, the system retrieves a photo from a data source, such as the one or more claim estimation photos 18 of FIG. 1. Next, in step 34, the system processes the photo to detect one or more features depicted in the photo. For example, an object recognition software application/module could be utilized to detect the one more features depicted in the photo, such as a piece of furniture, a rug, a plant, wall features, window features, trim, or other aspects and/or assets. Next, in step 36, the system generates a label for the photo based on the detected one or more features. Then, and step 38, the system assigns the label to the photo. The label could be stored as metadata associated with the photo, as a separate file or data structure associated with the photo, or otherwise stored by the system. Next, in step 40, the system determines a correct photo album of a claim file in which to store the photo and the label. For example, one or more of the albums 22 of the claim file 20 of FIG. 1 could be automatically selected by the system in this step. Finally, in step 42, the system stores the labeled photo in the correct photo album of the claim file. Advantageously, the processing steps of FIG. 2 significantly increase the speed and accuracy with which photos can be labeled and filed, thereby improving the functionality of the claims estimation software application 14 of FIG. 1.

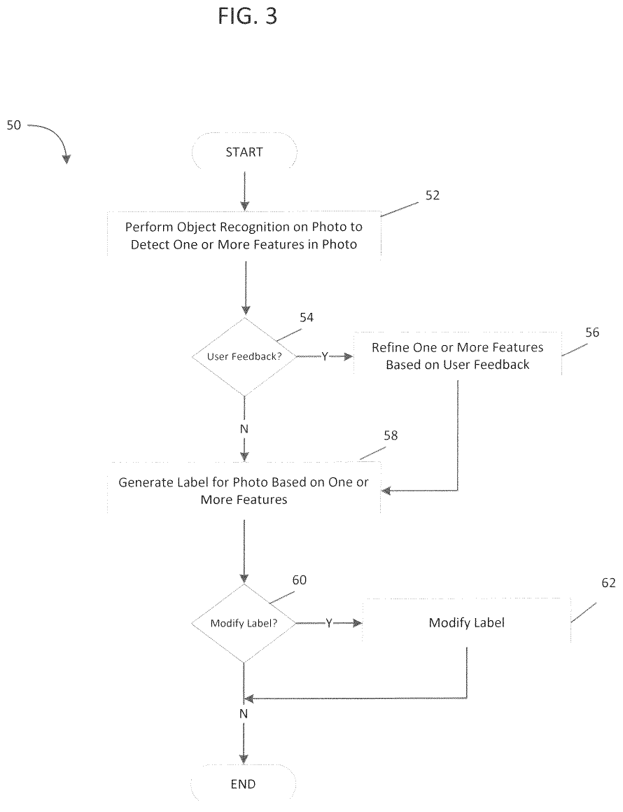

FIG. 3 is a flowchart, indicated generally at 50, illustrating additional processing steps carried out by the system 10 of FIG. 1. In step 52, the system performs object recognition on the photo to detect one or more features in the photo. In step 54, a determination is made as to whether user feedback is desired. If a positive determination is made, step 56 occurs, wherein the system refines one or more features based on user feedback. Otherwise, step 58 occurs, wherein the system generates the label for the photo based on the one or more features. Next, in step 60, a determination is made as to whether the user desires to modify the label associated with the photo. If so, step 62 occurs, and wherein the system permits to user to modify the label associated with the photo.

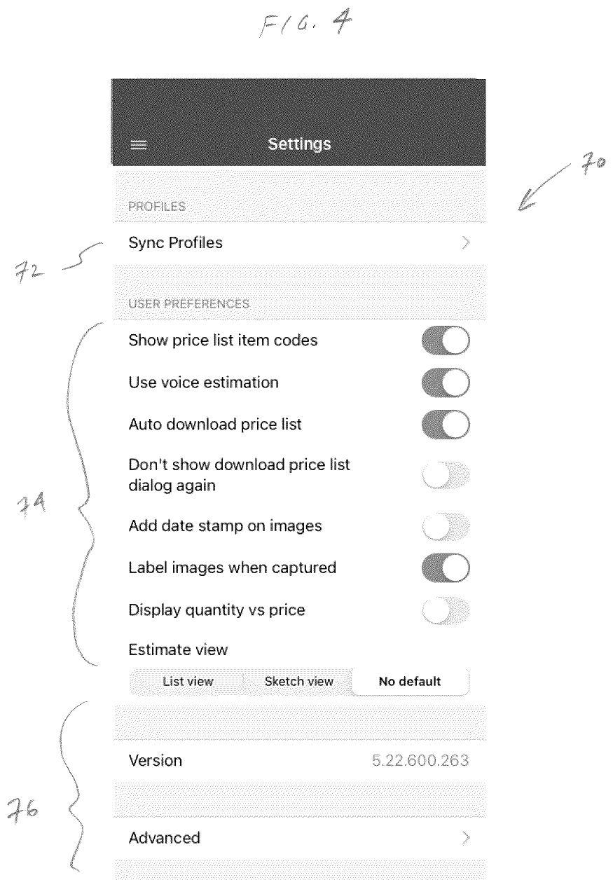

FIG. 4 is a screenshot illustrating a user interface screen 70 generated by the system of the present disclosure. Specifically, the user interface screen 70 includes a control 72 for allowing a user to define, alter, and/or synchronize one or more profiles. Additionally, the screen 70 includes a plurality of controls 74 for allowing a user to set various preferences such as showing price list item codes, using voice estimation, automatically downloading a price list, prohibiting a price list download from being displayed, adding a date stamp on an image, labeling images when captured, displaying quantities versus prices, and setting one or more desired views (e.g., list view, sketch view, etc.) associated with an estimate. Finally, screen 70 includes control 76 which indicates the version of the software and allows the user to set other advanced settings.

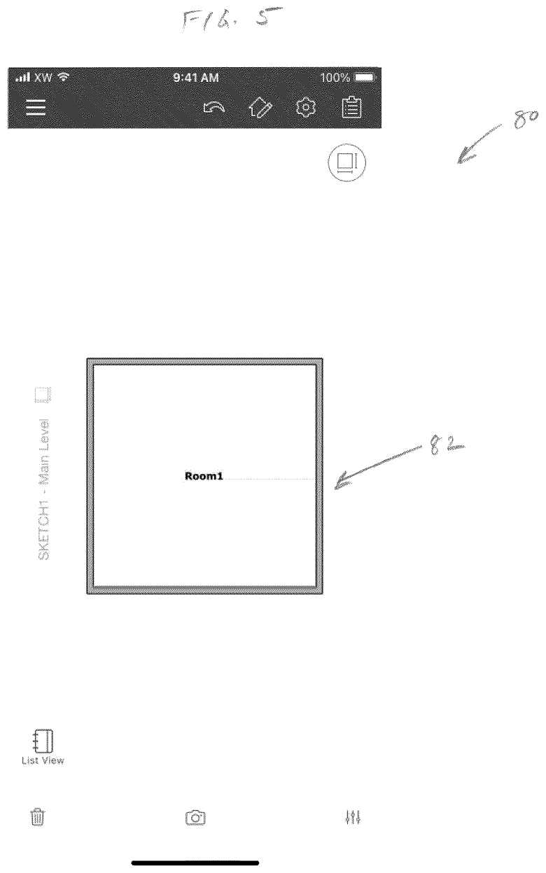

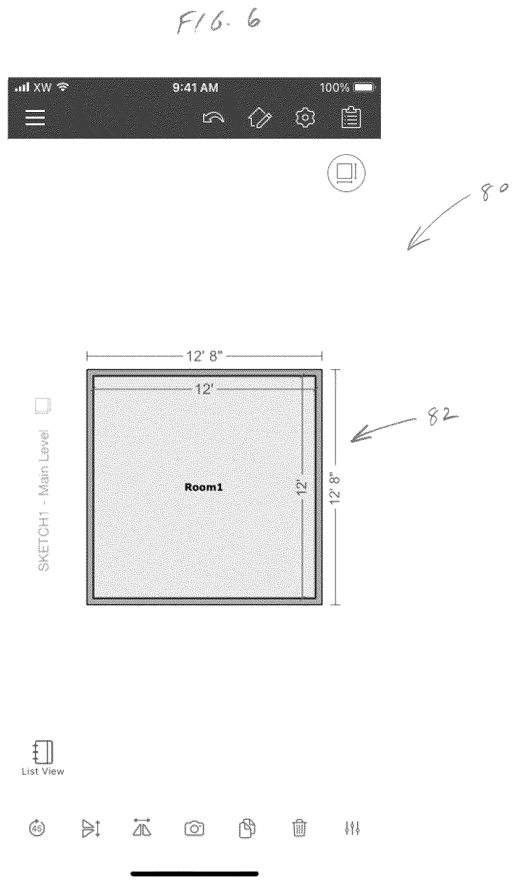

FIG. 5 is a screenshot of another user interface screen 80 generated by the system of the present disclosure. The screen 80 allows a user to graphically define or sketch a floor plan of a room, such as the room sketch 82 graphically depicted on the screen 80 of FIG. 5. Next, as illustrated in FIG. 6, the user can edit the room 82 (e.g., alter the walls of the room 82), which automatically updates measurements of various dimensions associated with the room 82.

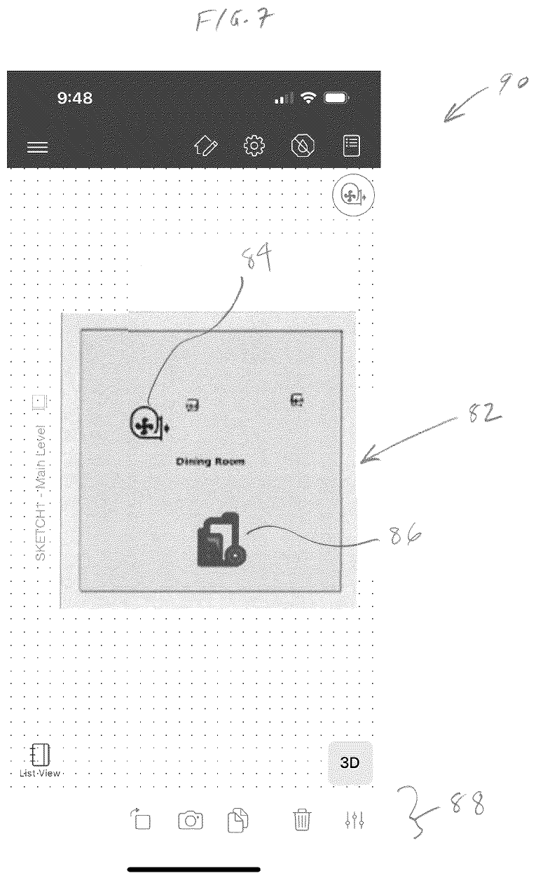

FIG. 7 is a screenshot illustrating another user interface screen 90 generated by the system of the present disclosure. The screen 90 allows the user to add one or more items to the room sketch 82, such as an icons 84 and 86 which correspond to one or more items positioned within the room sketch 82. For example, if the room sketch 82 corresponds to a dining room, there could be multiple icons corresponding to furniture or other objects positions within the dining room. Additionally, the screen 90 includes controls 88 which allow the user to perform various editing or other functions associated with defining the floor plan of a room as well as its contents.

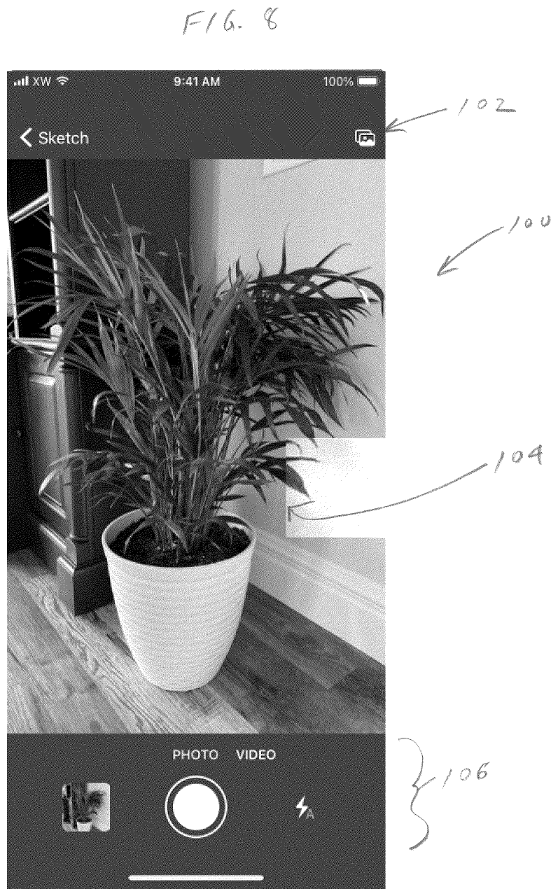

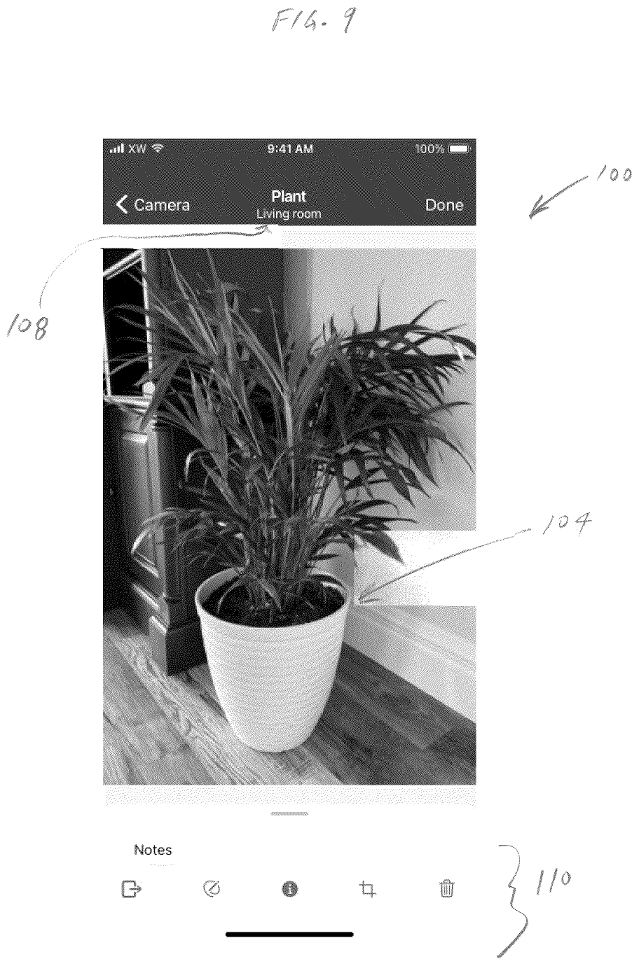

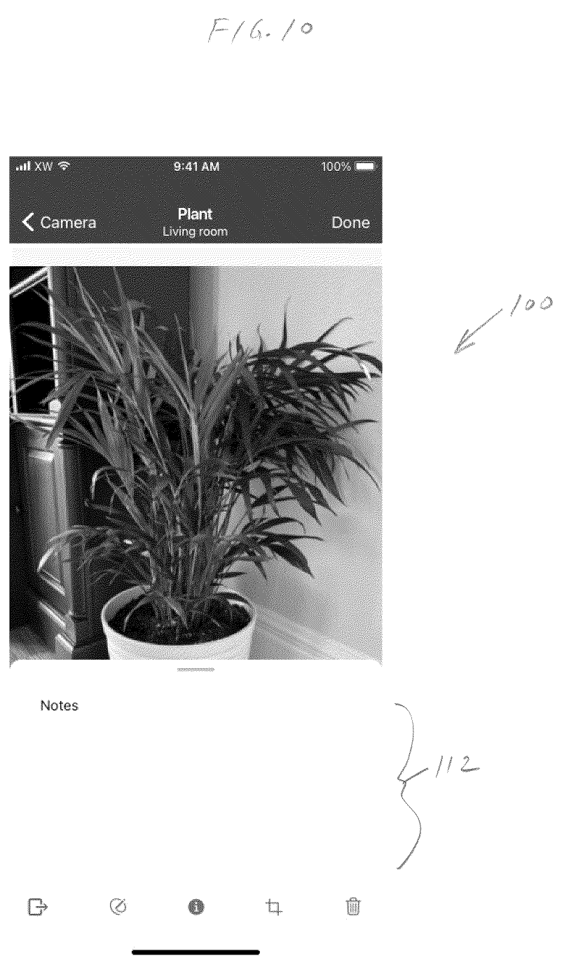

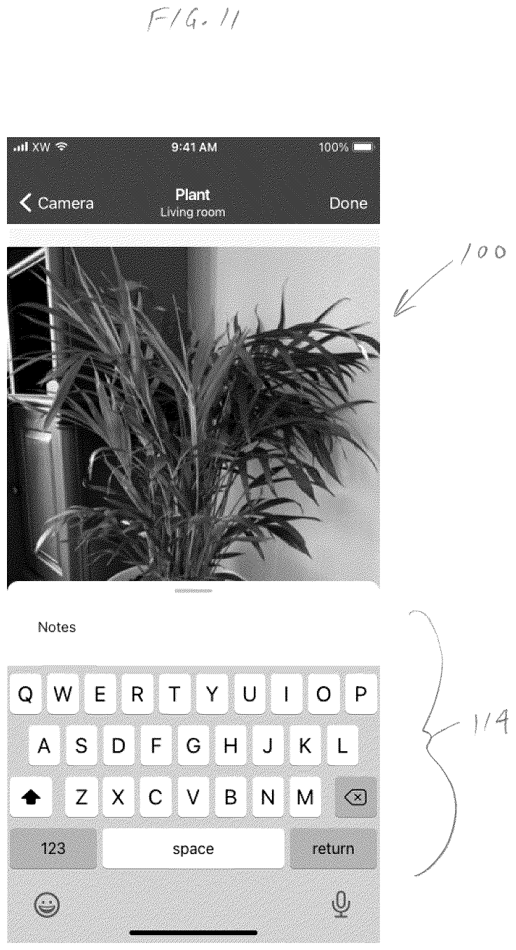

FIG. 8 is a screenshot illustrating another user interface screen 100 in accordance with the present disclosure. As can be seen, the screen 100 allows a user to take a photo of an object in a room, such as a photo 104 of a plant. Additionally, the user can control operation of the camera using one or more of the controls 106 of the screen 100. As illustrated in FIG. 9, when the icon 102 has been tapped by the user, the system automatically generates a label 108 associated with the photo 104. Specifically, the label 108 displayed in screen 100 indicates that the object shown in the photo 104 is a plant, and that the plant is positioned within a living room of a dwelling. The label 108 is automatically generated after the user takes the photo 104 and taps on the icon 102. It is noted that the label 108 could also be generated based upon the room where the photo 104 was taken, as well as details in a claim file associated with the room and/or items identified in the photo 104. Additionally, the screen 100 includes a plurality of controls 110 that allow the user to define and store one or more notes associated with the photo 104, as well as editing the photo or performing other functions. For example, as illustrated in FIG. 10, the screen 100 can include an expanded field 112 that allows the user to enter detailed notes associated with a photo. As illustrated in FIG. 11, to facilitate the entry of notes by the user, a keyboard 114 could be displayed by the system, and the user can type notes as desired using the keyboard 114. Further, the user can record and save a voice dictation (e.g., using a microphone of a smart phone), if desired.

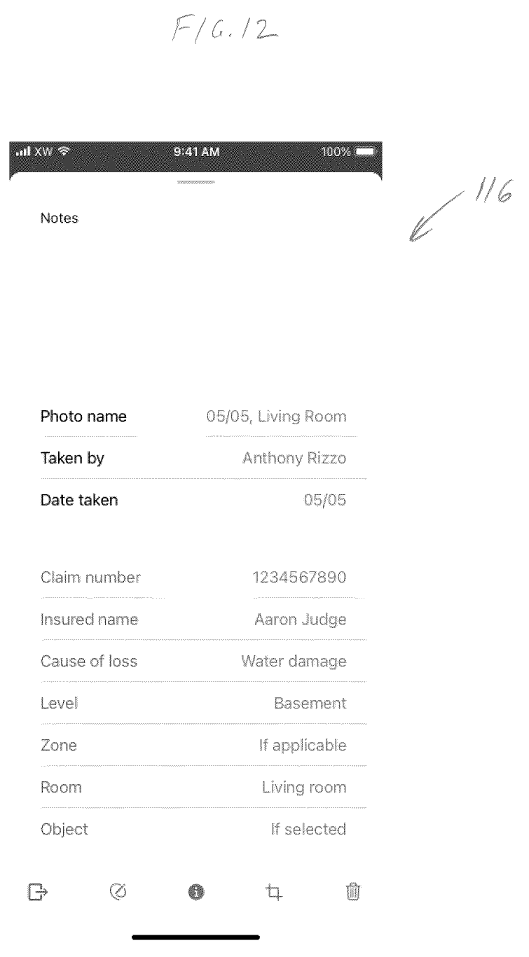

FIG. 12 is a screenshot illustrating another user interface screen 116 generated by the system of the present disclosure. As can be seen, the screen 116 includes fields associated with notes, as well as the name of the photo, the date that the photo was taken, and insurance claim number associated with the photo, the name of an insured party, a cause of loss of an object depicted in the photo, a level of a structure in which the object is located (e.g., basement), a zone (if applicable), a room associated with the object, and a description of the object. This information can form part of the photo labeling process, and can be gathered from a claim file associated with the photo and/or structures/objects depicted in the photo.

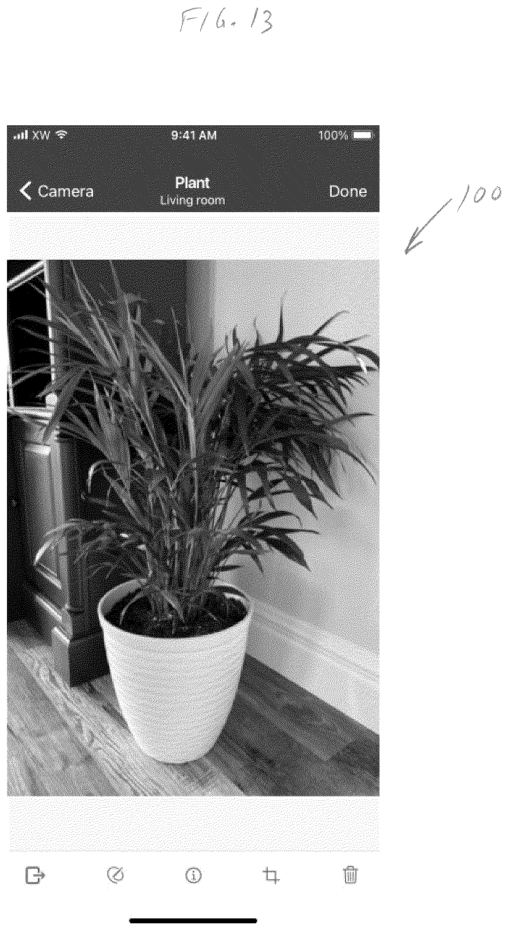

FIG. 13 is a screenshot of the user interface screen 100, wherein notes/information relating to a photo are not displayed. Advantageously, the user can choose to toggle whether notes associated with a photo are displayed.

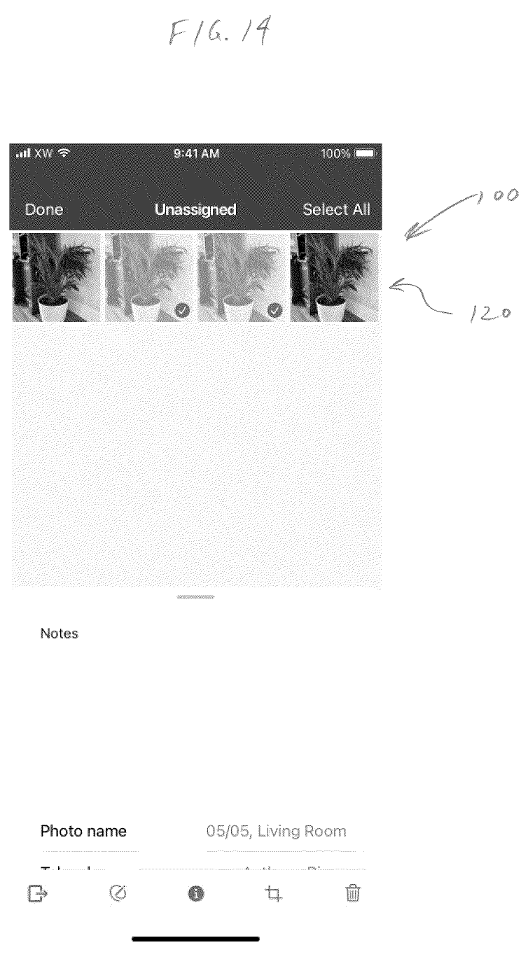

FIG. 14 is a screenshot of the user interface screen 100, wherein a photo selection panel 120 is displayed. The panel 120 allows the user to conduct bulk editing of notes and details associated with one or more photos. If a claim number or other type of information differs from image to image, the system can display such information in multiple table rows. Also, the rows are editable by the user.

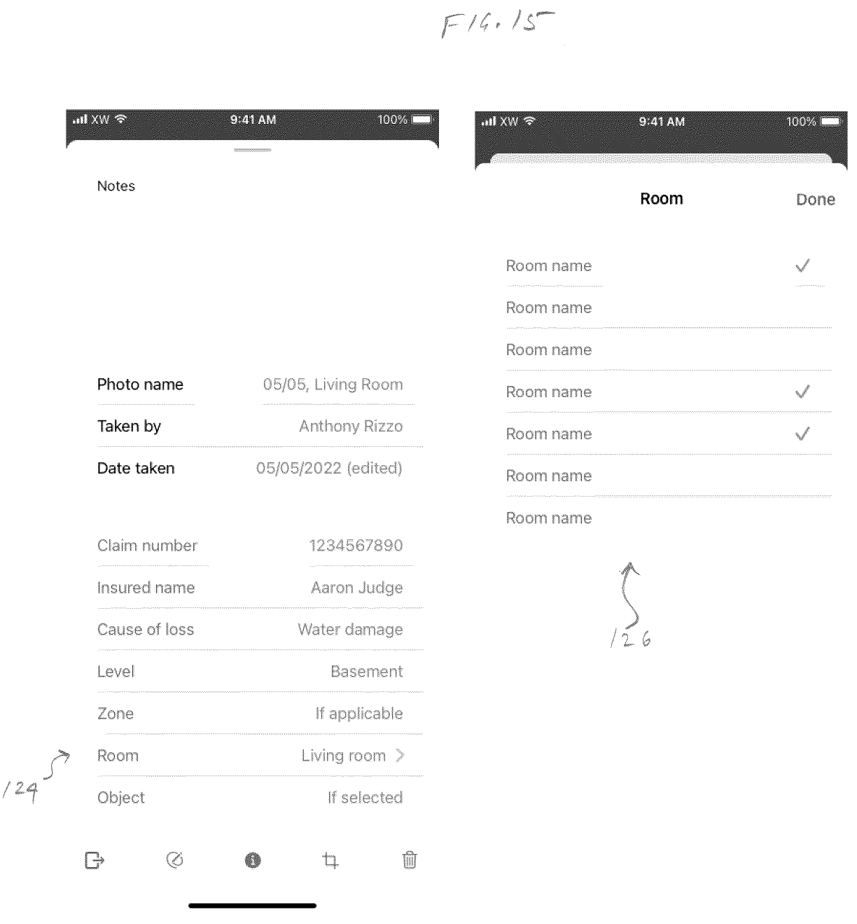

FIG. 15 includes screenshots of the user interface of the present disclosure, wherein the user can add detailed notes relating to an object depicted in a photo. Specifically, the fields 124 allow a user to enter and/or edit information such as an insurance claim number, the name of the insured, a cause of loss of the depicted object, a level of a structure/building where the object is located, a zone associated with the object, a room in which the object is located, and other information. Additionally, a room pull-down menu 126 allows the user to define and/or select one or more rooms associated with the object. Optionally, such definition/selection could be performed automatically by the system (e.g., using object recognition to guide the definition/selection process).

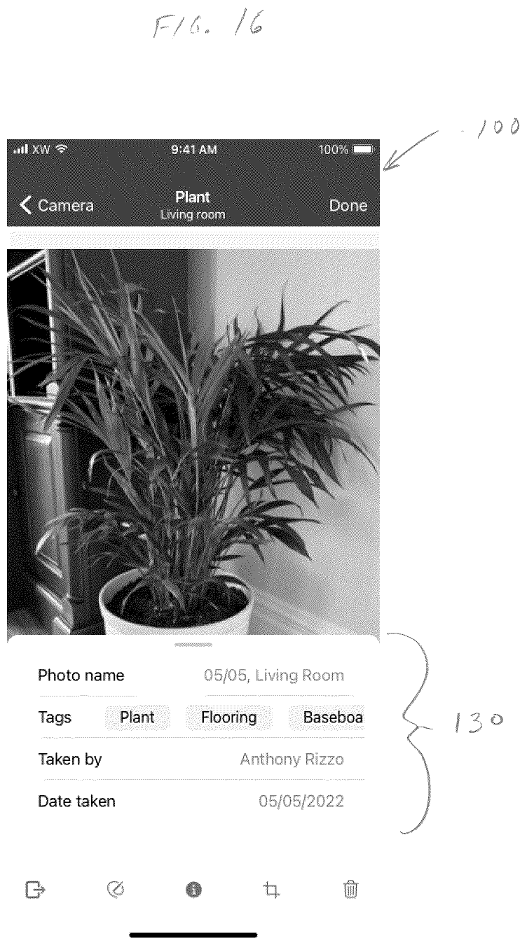

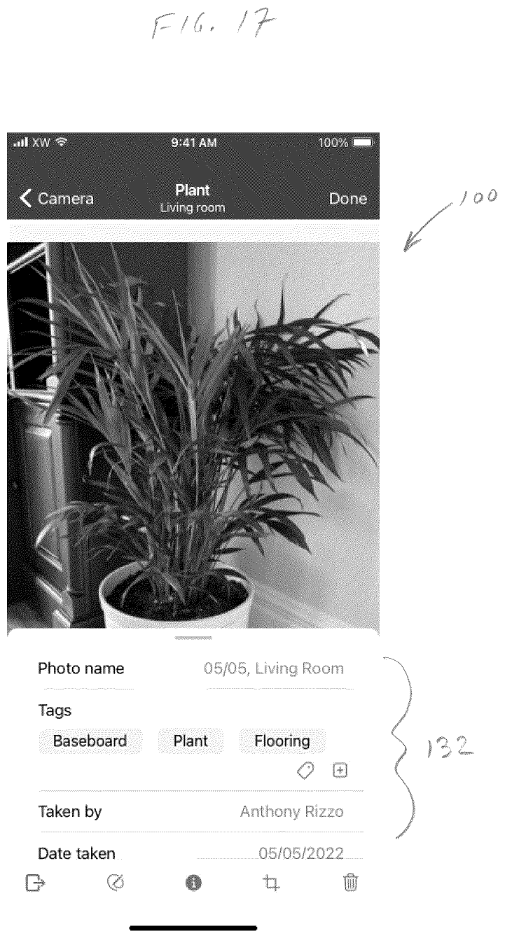

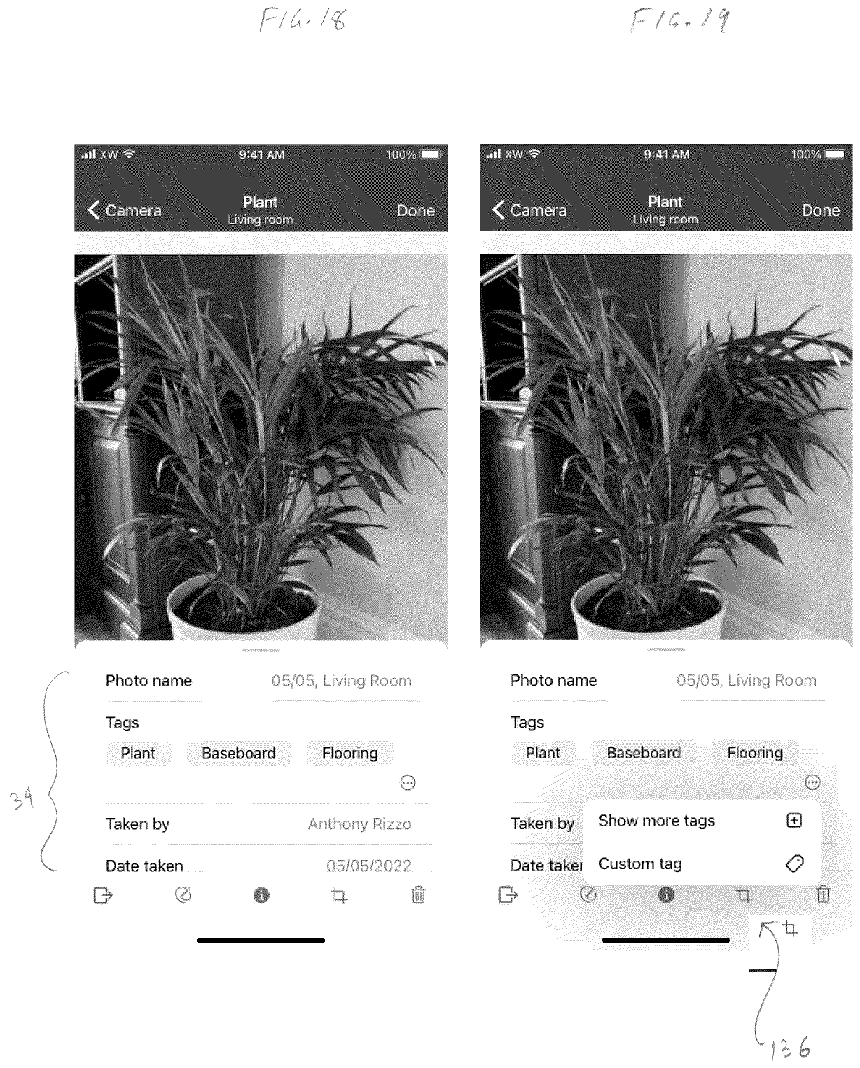

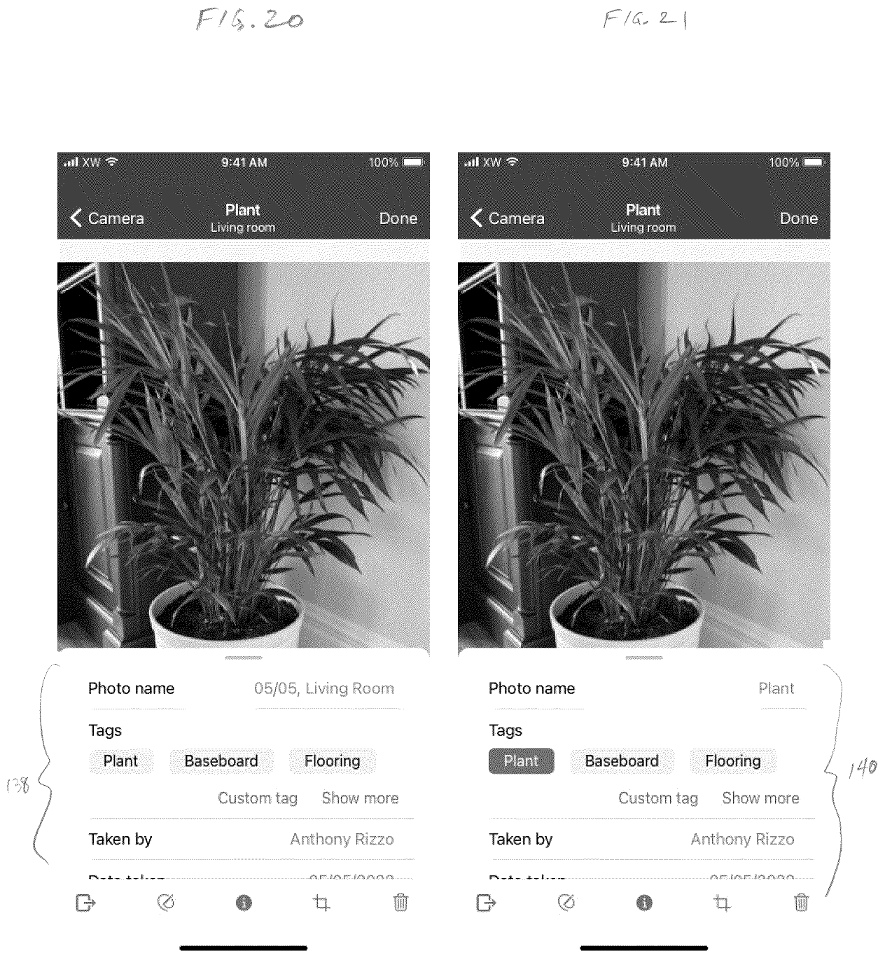

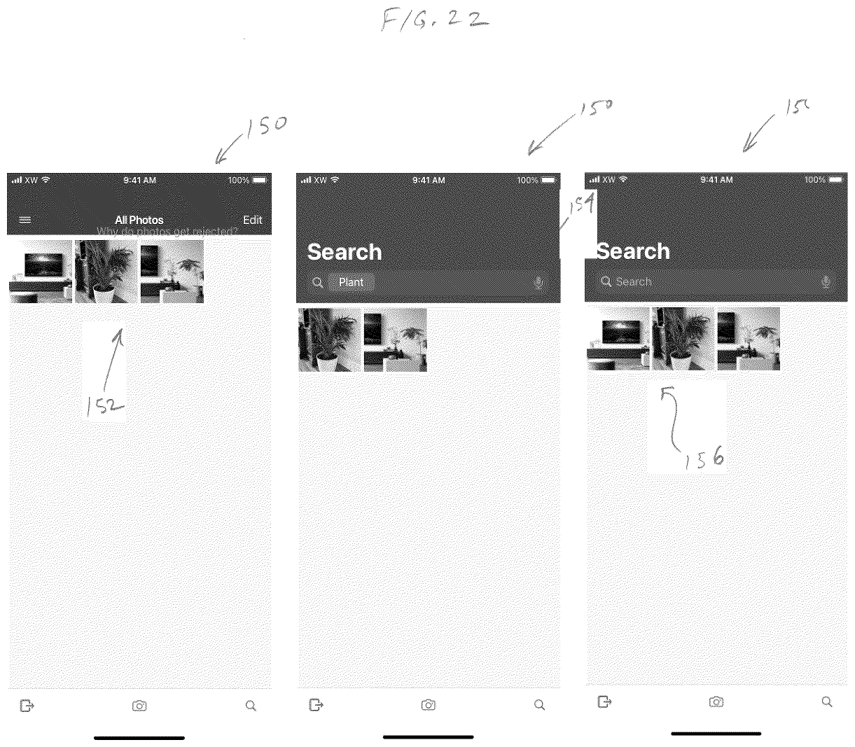

FIG. 16 is a screenshot of the user interface screen 100, wherein photo detail panel 130 is displayed. The panel 130 displays the name of the photo, one or more tags (labels) associated with one or more objects depicted in the photo (such as plant, flooring, baseboard, etc.), a name of an individual who took the photo, and the date the photo was taken. One or more of these fields could be edited by the user, if desired. In this regard, FIG. 17 illustrates a panel 132 wherein the user can add, delete, or edit one or more tags (labels) associated with a photo. Still further, as shown in FIGS. 18-19, the user can tap on a tag panel 134 in order to add/edit/delete a tag, and a menu 136 could be displayed which allows the user to select from a list of pre-defined tags (e.g., to be added to the photo) or to define one or more user-defined tags for the photo. As shown in FIGS. 20-21, fields 138 and 140 allow the user to select (tap on) one or more of the tags in order to select/edit the tag, and there are also “Custom tag” and “Show more” icons which allow the user to define one or more custom tags or to select one or more pre-defined tags.

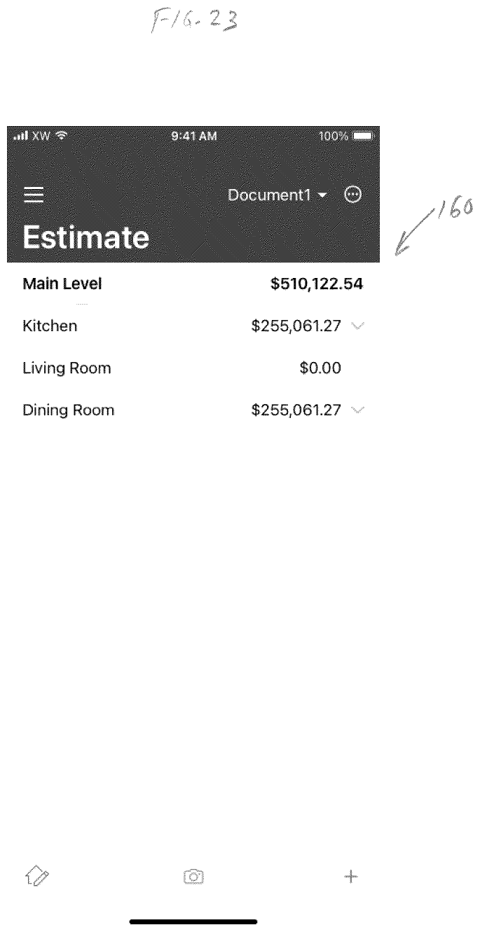

FIG. 22 illustrates a photo selection screen 150 which allows the user to rapidly search for one or more photos by specifying a label (tag). In the left depiction of the screen 150, the user can see all photos currently associated with a particular claim or album, and can select/edit same using photo selection panel 152. In the center depiction of the screen 150, a search bar 154 is provided, wherein the user can enter a text search string for a desired tag/label in order to search for relevant photos. For example, a user could enter the text string “plant” to search for all photos that depict a plant. Then, as shown in the right depiction of the screen 150, photos 156 which include an object corresponding to the search string are displayed to the user for subsequent selection and/or editing.

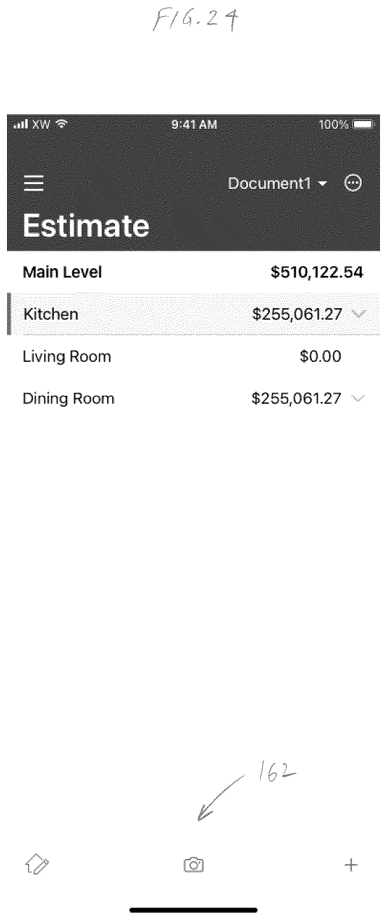

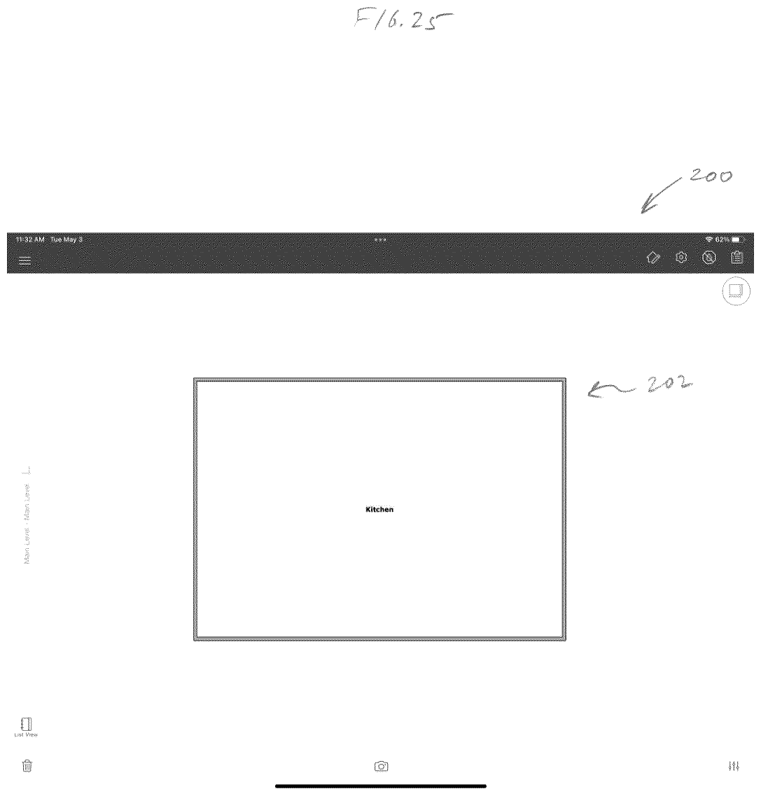

FIG. 23 is a screenshot showing a user interface screen 160 in accordance with the present disclosure, wherein detailed information about an insurance estimate can be displayed. Such estimate could include a breakdown of the entire estimate based on one or more parameters, such as room, level, structure, etc. The breakdown could be downloaded as a document, if desired. As shown in FIG. 24, a photo icon 162 could be accessed by the user so as to activate a camera and to allow the user to take a photo.

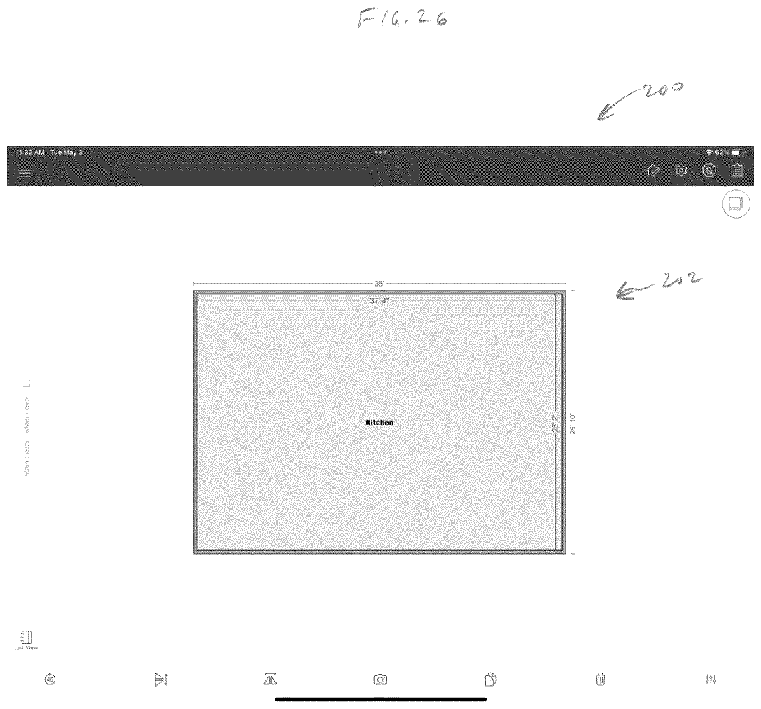

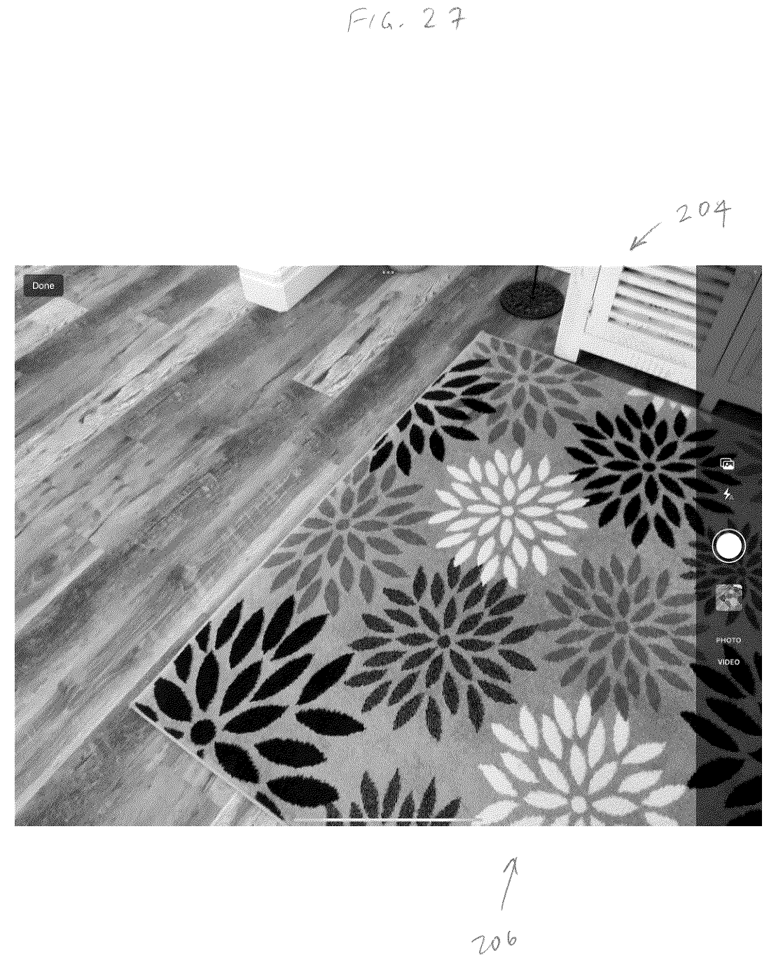

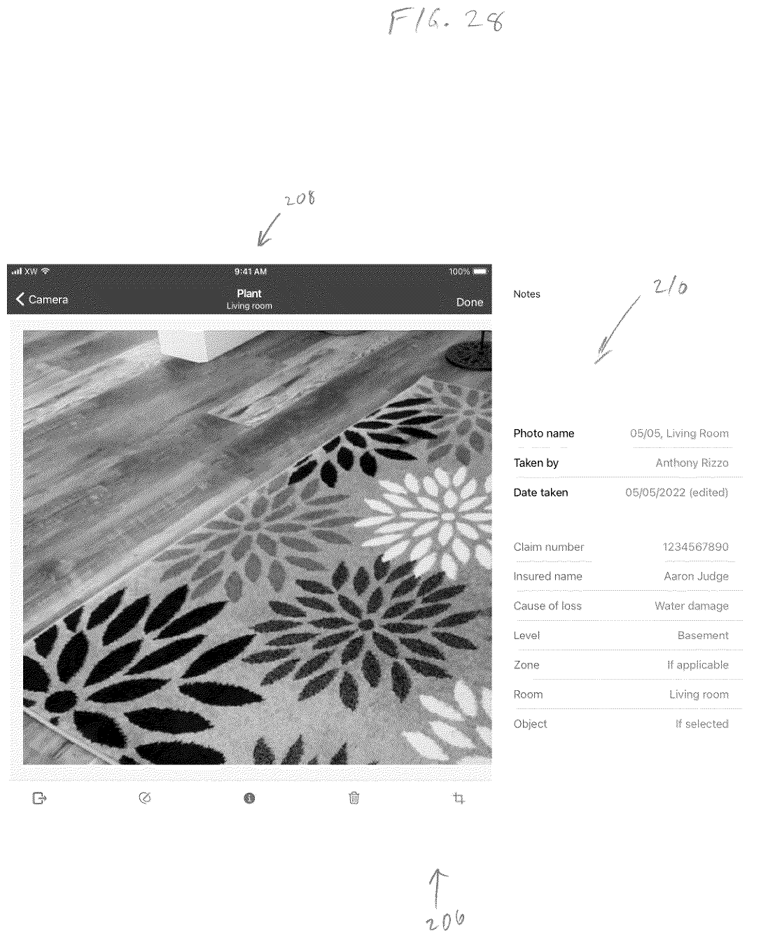

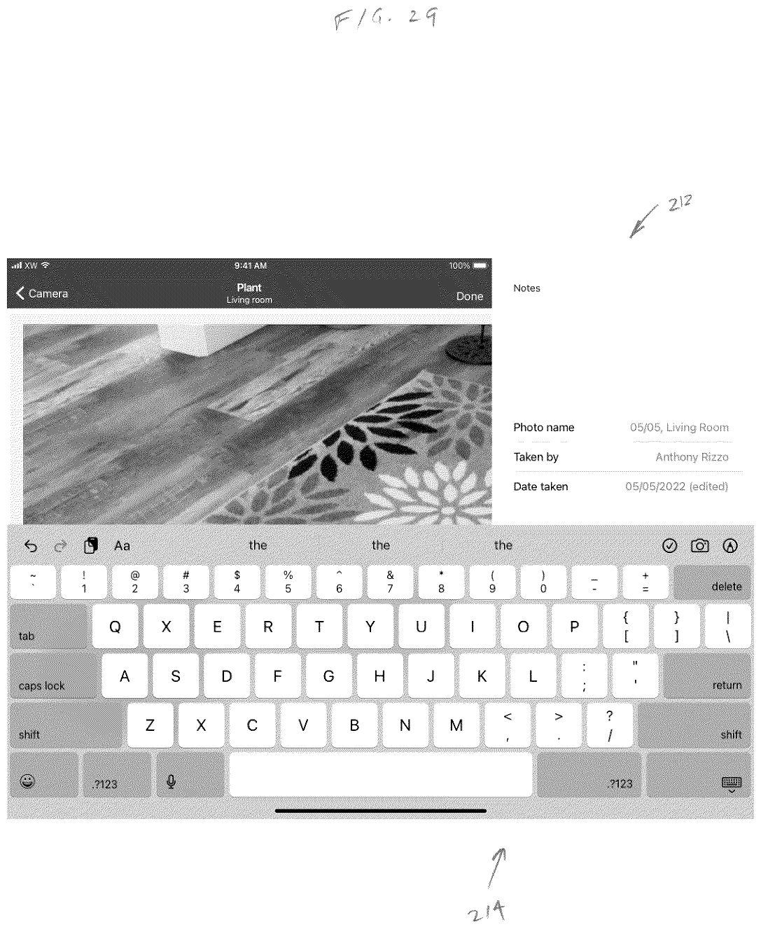

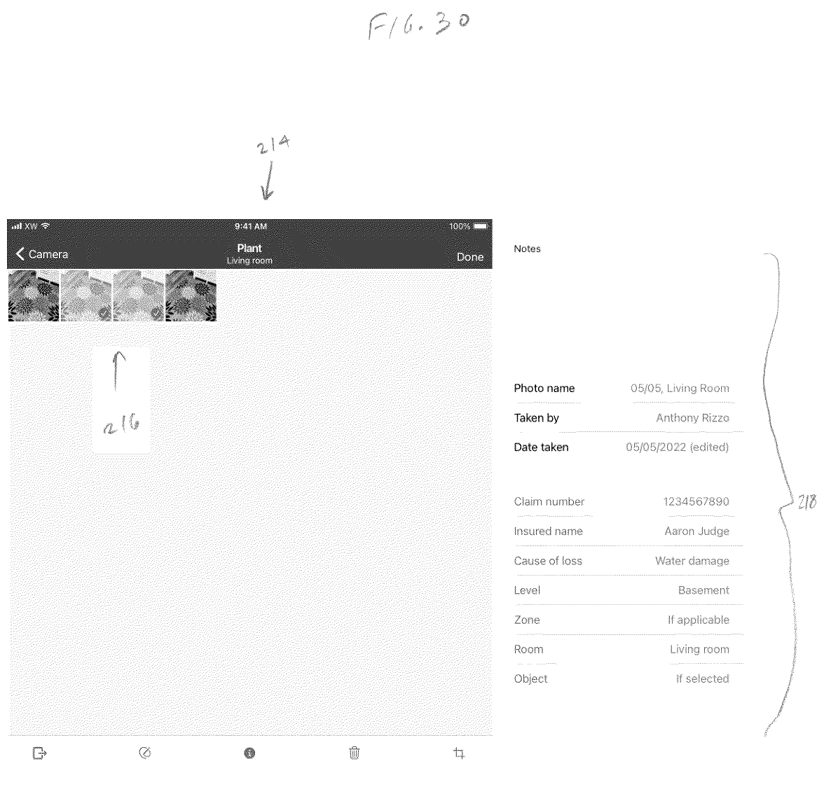

FIG. 25 is a screenshot illustrating another user interface screen 200 in accordance with the present disclosure, formatted for use on a tablet (e.g., iPad) computer. The screen 200 allows the user to generate a graphical sketch 202 of a room or other structure of a building. As shown in FIG. 26, the sketch 202 could include measurements which could be automatically calculated and displayed by the system. As shown in FIG. 27, a user interface screen 204 allows the user to take a photo 206 of an object (here, a rug) in the room or structure of the building, using a camera of the tablet computer. As shown in FIG. 28, detailed notes 210 can be defined, added, deleted, or edited and associated with the photo 206. As further shown in FIG. 29, the notes 210 could include a free-text field 212 where the user can type notes using a keyboard 214.

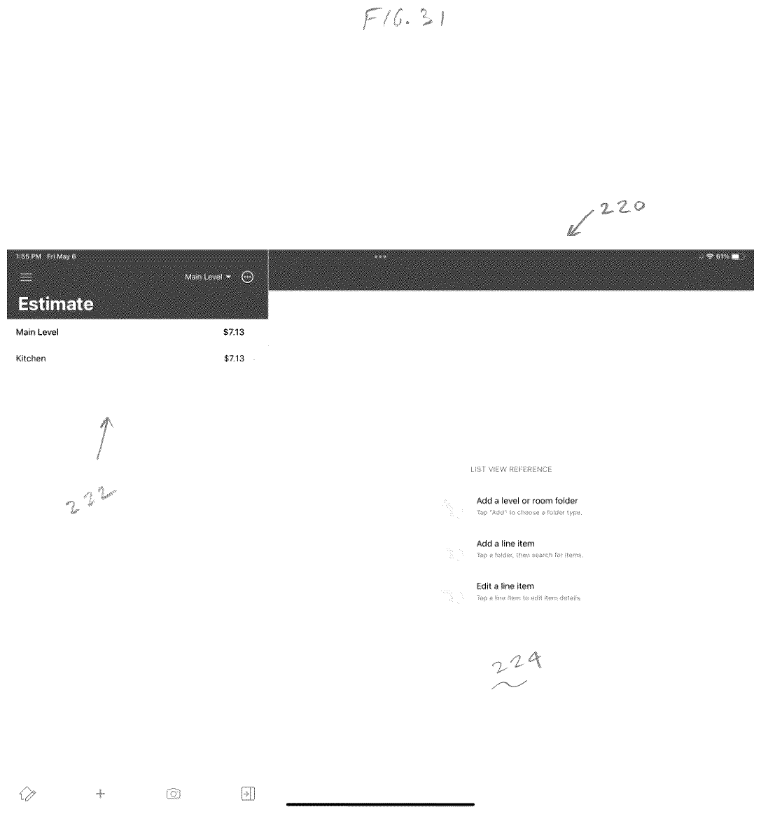

FIG. 30 is a screenshot of another user interface screen 214 for a tablet computer, wherein the user can select one or more photos 216 and can also access, add, edit, or delete notes 218 associated with the one or more photos 216.

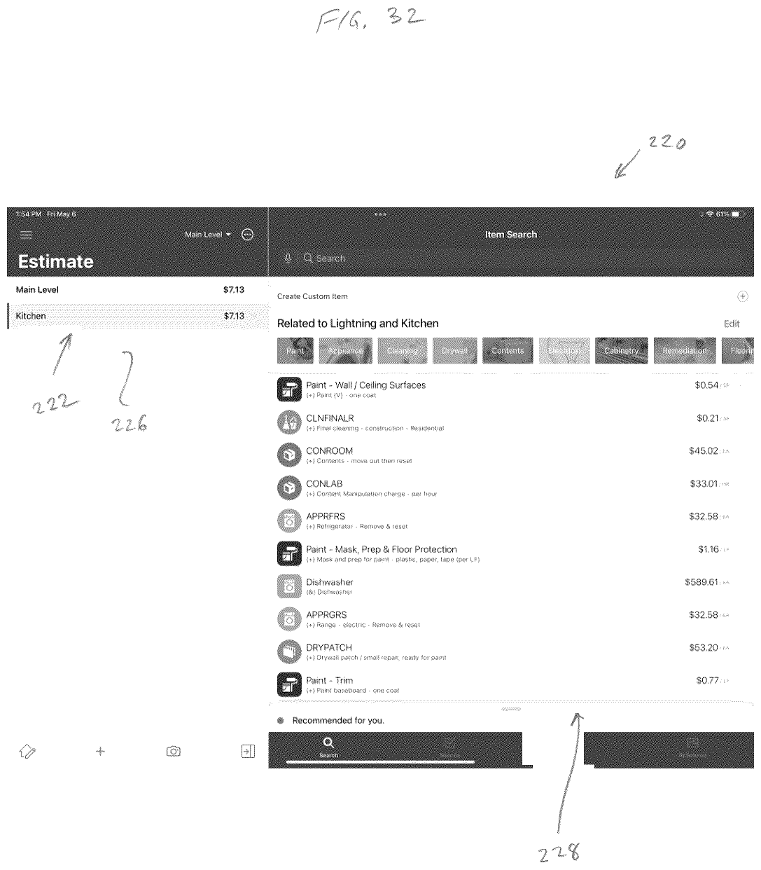

FIG. 31 is a screenshot of another user interface screen 220 for a tablet computer, wherein the user can select on an estimate for a particular level of a building using pull-down control 222, which causes a detailed estimate for that level to be displayed in panel 224. Finally, FIG. 32 is a screenshot of the user interface 220, wherein estimate search results are displayed in panel 228 in response to a user selecting a specific estimate 226 from the pull-down 222.

While the systems and methods of the present disclosure have been described in connection with insurance claims estimation, it is noted that the systems and methods of the present disclosure could be utilized in connection with other fields of endeavor, such as digital photography management, medical image management, or other fields of endeavor.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A machine learning system for automatic photo labeling and filing, comprising:
a computing system;
a claims estimation software application executed by the computing system, the claims estimation software application receiving a plurality of claim estimation photos relating to an insurance claim; and
a photo labelling and filing software module in communication with the claims estimation software application and executed by the computer system, the photo labelling and filing software module configured to:
retrieve a photo of the plurality of claim estimation photos;
process the photo using object recognition to detect one or more features in the photo;
generate a label for the photo based on the one or more features detected in the photo;
assign the label to the photo;
determine a photo album of a claim file of the claims estimation software application in which to store the photo; and
storing the photo in the photo album of the claim file.

2. The system of claim 1, wherein the claims estimation software application receives user feedback relating to the one or more features detected in the photo.

3. The system of claim 2, wherein the claims estimation software application refines the one or more features based on the user feedback.

4. The system of claim 1, wherein the system generates a user interface screen allowing a user to define, alter, or synchronize one or more profiles and to set preferences associated with an estimate.

5. The system of claim 1, wherein the system generates a user interface screen allowing a user to graphically define or sketch a floor plan of a room.

6. The system of claim 5, wherein the system allows a user to add one or more items to the floor plan of the room.

7. The system of claim 1, wherein the system allows a user to take a photo of an object in a room.

8. The system of claim 7, wherein the system automatically generates a label associated with the photo of the object.

9. The system of claim 8, wherein the system allows a user to take notes relating to the photo of the object.

10. The system of claim 9, wherein the system associates the photo of the object with one or more of a date the photo was taken, an insurance claim number, a name of an insured party, a cause of loss of an object depicted in the photo, a level of a structure in which the object is located, a zone, a room associated with the object, or a description of the object.

11. The system of claim 1, wherein the system displays a photo selection panel for allowing a user to conduct bulk editing of the plurality of claim estimation photos.

12. The system of claim 1, wherein the system generates a photo selection screen allowing a user to search for one or more photos by specifying a label.

13. The system of claim 1, wherein the system displays information about an insurance estimate associated with one or more of the plurality of claim estimation photos.

14. A machine learning method for automatic photo labeling and filing, comprising:
receiving by a claims estimation software application executing on a computing system a plurality of claim estimation photos relating to an insurance claim;
retrieving a photo of the plurality of claim estimation photos;
processing the photo using object recognition to detect one or more features in the photo;
generating a label for the photo based on the one or more features detected in the photo;
assigning the label to the photo;
determining a photo album of a claim file of the claims estimation software application in which to store the photo; and
storing the photo in the photo album of the claim file.

15. The method of claim 14, further comprising receiving user feedback relating to the one or more features detected in the photo.

16. The method of claim 15, further comprising refining the one or more features based on the user feedback.

17. The method of claim 14, further comprising generating a user interface screen allowing a user to define, alter, or synchronize one or more profiles and to set preferences associated with an estimate.

18. The method of claim 14, further comprising generating a user interface screen allowing a user to graphically define or sketch a floor plan of a room.

19. The method of claim 18, further comprising allowing a user to add one or more items to the floor plan of the room.

20. The method of claim 14, further comprising allowing a user to take a photo of an object in a room.

21. The method of claim 20, further comprising automatically generating a label associated with the photo of the object.

22. The method of claim 21, further comprising allowing a user to take notes relating to the photo of the object.

23. The method of claim 22, further comprising associating the photo of the object with one or more of a date the photo was taken, an insurance claim number, a name of an insured party, a cause of loss of an object depicted in the photo, a level of a structure in which the object is located, a zone, a room associated with the object, or a description of the object.

24. The method of claim 14, further comprising displaying a photo selection panel for allowing a user to conduct bulk editing of the plurality of claim estimation photos.

25. The method of claim 14, further comprising generating a photo selection screen allowing a user to search for one or more photos by specifying a label.

26. The method of claim 14, further comprising displaying information about an insurance estimate associated with one or more of the plurality of claim estimation photos.
